(19) United States
(12) Patent Application Publication
(10) Pub. No.: US 2004/0155961 A1
(43) Pub. Date: Aug. 12, 2004

(54) Apparatus and method for controlling display of video camera signals received over a powerline network

(76) Inventors: Louis Robert Litwin JR., Plainsboro, NJ (US); John William Richardson, Hamilton, NJ (US); Kumar Ramaswamy, Princeton, NJ (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/364,133

(22) Filed: Feb. 11, 2003

(51) Int. Cl. H04N 7/18

(52) U.S. Cl. 348/155; 348/584; 375/240.01

(57) ABSTRACT

An apparatus for controlling display of a video camera signal received over a powerline network includes a powerline modem for receiving a video camera signal over a powerline network, a security controller for receiving detection signals indicative of a security breach condition, and a signal converter for converting said video camera signal to another format.

### BACKGROUND

1. Technical Field

This disclosure relates to powerline modem networks and, more particularly to controlling display of video camera signals received over a powerline modem network.

2. Description of the Related Art

Powerline modems are communication devices that are able to communicate over the electrical power distribution network in a home or office. These modems enable multiple devices to communicate with one another by using the power network as a transmission medium. For example, a computer equipped with a powerline modem can send/receive data from a similarly-equipped home appliance such as a stereo. The bandwidth of such a system is high enough to allow the transmission of compressed digital video and audio as well as other forms of data.

A particular application of powerline modems that is relevant to this invention is the use of powerline modems in digital video security camera scenarios. The use of a powerline modem is advantageous in this application because security cameras can be set up anywhere there is a power outlet and their video/audio signals can be sent, via the powerline network, to a master device for display.

Accordingly, there is a need for enabling controlled display of video or audio information transmitted over a powerline network.

### SUMMARY OF THE INVENTION

An apparatus for controlling display of a video camera signal received over a powerline network including a powerline modem for receiving a video camera signal over a powerline network, a security controller for receiving detection signals indicative of a security breach condition, and a signal converter for converting the video camera signal to another format.

An apparatus for integrating with a television for controlling display of a video camera signal received over a powerline network includes a powerline modem for receiving a video camera signal over a powerline network, and a signal converter for converting the video camera signal to a format suitable for a television input.

A method for controlling a security camera signal includes the steps of receiving a security camera signal over a powerline network, detecting a security condition, and changing the security camera signal into a form for a display device.

A computer readable medium containing software instructions that, when executed by a processor, performs the steps of receiving security information from a security camera over a powerline network and enabling display of security images received from the security camera in response to the receiving of the security information.

These and other objects, features and advantages of the present invention will become apparent from the following detailed description of illustrative embodiments thereof, which is to be read in connection with the accompanying drawings.

### BRIEF DESCRIPTION OF DRAWINGS

This disclosure will present in detail the following description of preferred embodiments with reference to the following figures wherein:

FIG. 1 is a block diagram showing an exemplary powerline modem network with multiple devices interconnected over the powerline network;

FIG. 2 is a diagram of a powerline modem network with multiple security cameras and television interconnected over the powerline network in accordance with an embodiment of the present invention;

FIG. 3 is a diagram of an exemplary powerline-enabled security camera for use with the powerline network in accordance with the present invention;

FIG. 4 is a diagram of a powerline modem network with multiple security cameras and television interconnected over the powerline network in accordance with an alternative embodiment of the present invention;

FIG. 5 is a diagram of an apparatus for controlling a video camera signal to a television over a powerline network in accordance with the present invention; and

FIG. 6 is a block diagram of an alternative embodiment of an apparatus for controlling a video camera signal to a television over a powerline network in accordance with the present invention.

### DETAILED DESCRIPTION OF PREFERRED EMBODIMENTS

The invention is for use in a digital video security camera system that transmits its video, preferably as compressed digital video and audio signals, using powerline modem technology to enable the display of security camera output on television sets. Most importantly, the invention enables the user to watch television shows and security camera activity on the same television set. The invention consists of the appropriate hardware and software that enables the television programming to be interrupted automatically in order to display security camera activity to the user after significant activity has been detected.

Specifically, the security cameras are connected to a television set top box. This set top box contains a powerline modem and a TV tuner and is connected to the user's television set. In addition to normal set top box activities, our novel set top box acts as a security controller by providing a central processing point for incoming security camera video signals that are received from the powerline modem network. In addition, the set top box acts as a signal converter by converting the security camera video/audio to a format (e.g., NTSC) that is suitable for display on a typical television set.

By using a combination motion or audio detection hardware and software on the set top box activity can be detected by the set top box with the cameras. If activity is detected, the set top box can display the video from the corresponding camera on the television screen. One option is to interrupt the current television show by using the onboard TV tuner to display a full-screen shot of the video camera. Another option is to use the onboard TV tuner to display a Picture-In-Picture (PIP) window that would allow the user to watch both the television show on the full screen with the security camera view overlaid on top of the television show.

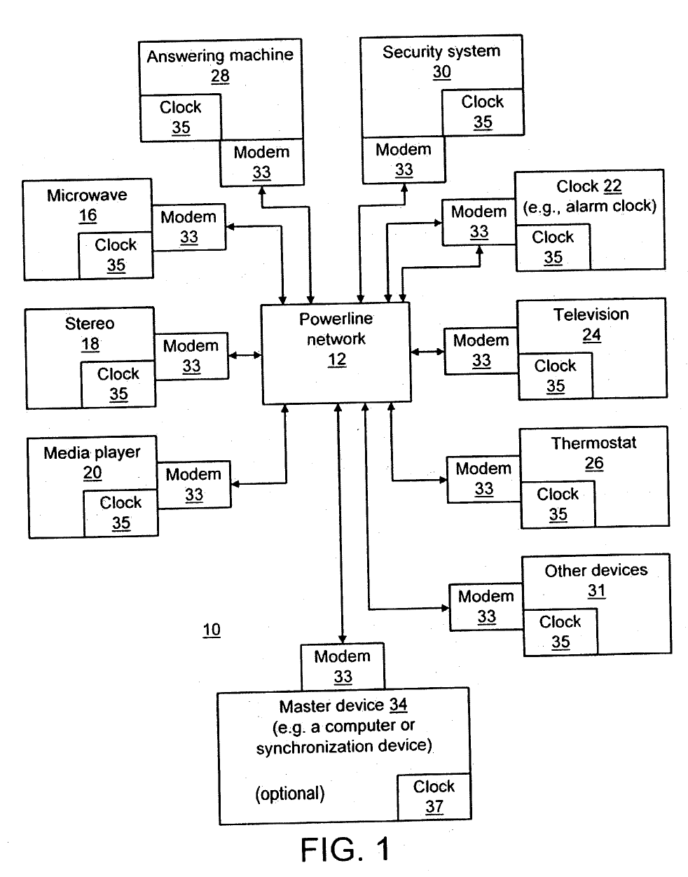

Referring now in specific detail to the drawings in which like reference numerals identify similar or identical elements throughout the several views, and initially to FIG. 1, a block diagram of an illustrative network 10 in which the present invention can be practiced. A powerline network 12, which may include a hardwired electrical power system for a home or building, is connected to each of a plurality of devices. These devices may include a microwave 16, a stereo 18, a VCR/DVD or other media player 20, an alarm clock 22, a television 24, a programmable thermostat 26, an answering machine 28, an alarm or security system 30, or any clock devices 31 which plug into the electrical power system. This list is not exhaustive and other devices are contemplated by the present invention. Each device includes a powerline modem 33, which permits communication between these devices themselves and/or a master device 34. Each device can also optionally include a clock 35 for synchronization of devices on the powerline network. Powerline modems 33 preferably include an embedded processor. The processor of powerline modem 33 can run software whose functions include, but are not limited to, data modulation/demodulation as well as upper-layer network functions such as packet processing.

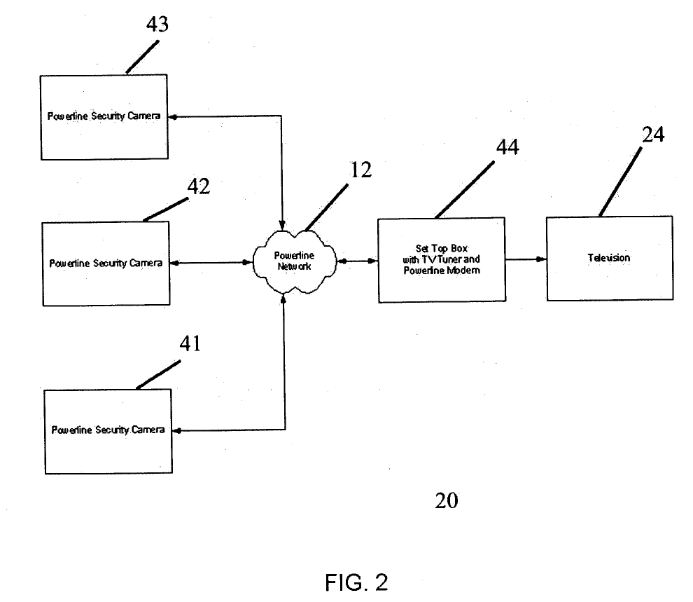

Referring now to FIG. 2, there is shown a diagram 20 of security cameras 41-43 connected to a set top box (STB) 44 and television 24 over a powerline network 12.

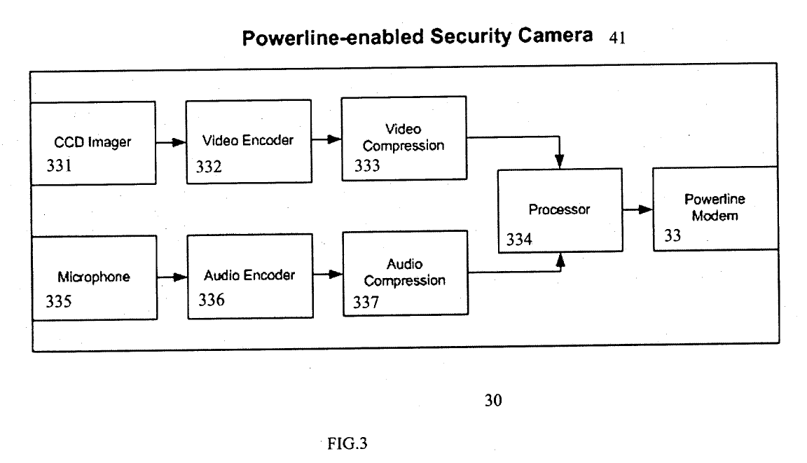

FIG. 3 is diagram 30 of an exemplary powerline-enabled security camera 41-43 for use with the powerline network in accordance with the present invention. A charge-coupled device CCD imager 331 in conjunction with a video encoder 332 allows the camera to capture the information as digital video. Secondly, the digital video is then compressed 333 in order to reduce the amount of bandwidth consumed during transmission. And finally, the digital video is then sent frame by frame to the embedded processor 334, which then packetizes the digital video for modem 33 transmission on the powerline network. A microphone 335 in conjunction with an audio encoder 336 captures the audio information as digital audio. The digital audio is then compressed 337 in order to reduce the amount of bandwidth consumed during transmission. And finally, the digital audio is then sent to the embedded processor 334, which then packetizes the digital audio together with the digital video.

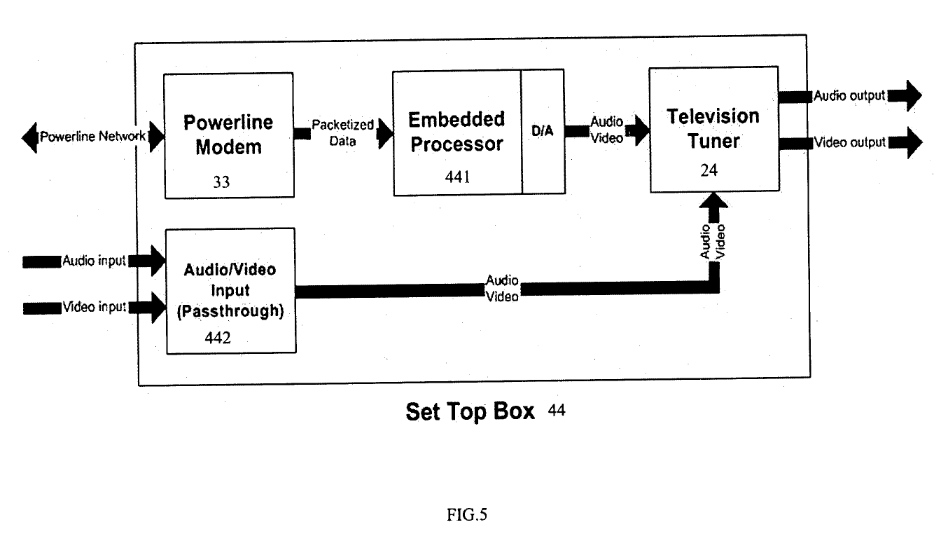

Referring to FIG. 5 is a diagram of a set top box 44 for controlling a video camera signal to a television over a powerline network. The set top box 44 has a pass through audio/video input 442 directly to the television tuner 24 for television programming input to the television display. The set top box 44 has another signal path in which the digital audio/video signal, received from the security camera 41-43 over the powerline network 12 into the modem 33, is sent to an embedded processor 441 and converted D/A to an analog signal for the television tuner 24.

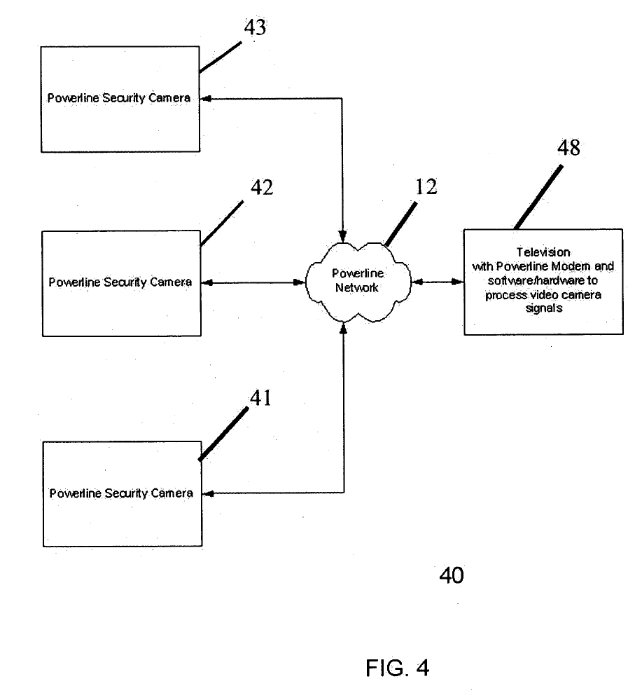

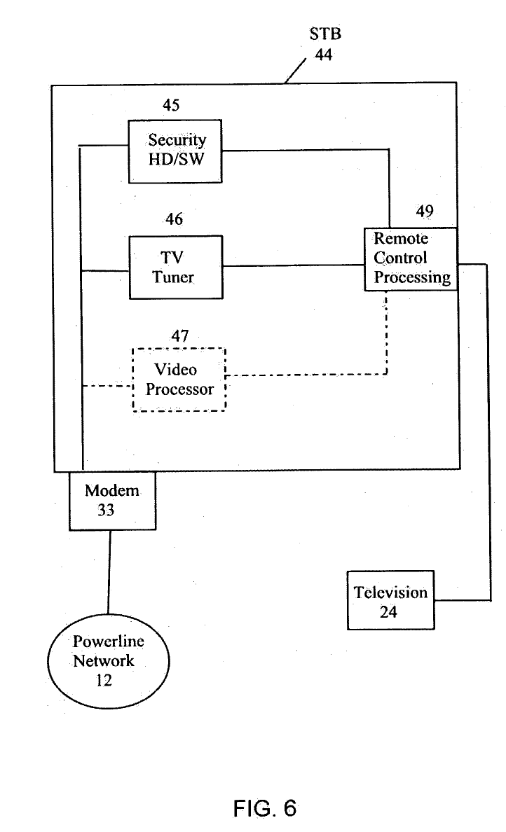

FIG. 6 is a block diagram of an alternative embodiment of an apparatus for controlling a video camera signal to a television over a powerline network. The cameras 41-43 can record video, and possibly audio, and send the recorded video or audio over the powerline network 12 where other powerline modem devices can receive and display the video if needed. A device for receiving the video from a security camera 41-43 can be a set top box (STB) 44 with a powerline modem 33 and a television tuner 46. The set top box 44 can decode the video that comes over the powerline network 12 from the security camera 41-43. Hardware and software 45 for processing security breach related signals can reside in the security system 30. Security cameras 41-43, set top box 44 (as shown in FIG. 6), or the television (as shown in FIG. 4) can include hardware and software for processing security related signals. The hardware software 45 can be configured to detect motion meeting a security breach condition and signal the set top box to control the television to display images captured by the security camera 41-43 in real time. If a security breach or any activity is detected the set top box can employ an on-board television channel tuner 46 to send video from the security camera to the television for display.

The set top box can feed the security camera signal to the television for displaying the security camera viewing instead of television programming. Alternatively, upon detecting any security breach activity the security camera signal can be sent to a television's picture-in-picture (PIP) input and display the security camera images over a portion of the television programming display. This would permit viewing the security scenes while still viewing television program viewing during detection of security breaches due to nuisance activity.

The STB can have either a television frequency tuner 46 or a video processor 47 for providing composite video or both. Composite video is a video signal in which all video elements have been combined, in contrast to component video. Composite video is utilized in the world's three TV standards: NTSC, PAL, and SECAM.

If the STB 44 detects activity (either motion, audio, or both), it can automatically display the video camera output on the television screen by sending commands to the television that tune it to the specific channel, if the STB has a tuner. Alternatively, the STB can send a composite video to a television with composite video input. The commands could be sent to the TV by way of an infrared IR repeater cable (typical industry name is IR Blaster) connecting the STB and the television or other radio signal control system 49 between a handheld remote transmitter and a receiver at the STB (or television in the embodiment according to FIG. 6). The STB can then send IR commands to the television to tell it to switch to displaying the video camera output. The commands could alternatively be sent to the television from the STB by way of a powerline modem link.

The video camera output can be displayed as either a full-screen view or as a picture-in-picture (PIP) view that is overlaid on top of the current television show based on the commands from the STB. Alternatively, the user can control display of the security camera viewing on the television by manually controlling the set top box to feed the security camera signal to the television at will, even if no activity is detected.

In an alternative embodiment of the invention, as shown by the diagram in FIG. 6, the functions of the STB discussed with respect to FIG. 2 can be integrated into the television chassis. The television can include a powerline modem 33 and hardware and software 45 to process the security camera output signals and show the security camera viewing on the television display. Security control signal processing circuits 45 can also be integrated into the television chassis or reside outside the television and feed a control circuit for cutting in the video camera images onto the television display as a full picture or a picture-in-picture display

Preferred embodiments for security camera operation and display over a powerline modem network have been described which are intended to be illustrative and not limiting. It is noted that variations are possible by those skilled in the art in light of the above teachings. It is therefore to be understood that changes may be made in the particular embodiments of the invention disclosed which are within the scope and spirit of the invention as outlined by the appended claims.

What is claimed is:

1. A an apparatus for controlling display of a video camera signal received over a powerline network comprising:
a powerline modem for receiving a video camera signal over a powerline network;
a security controller for receiving detection signals indicative of a security breach condition; and
a signal converter for converting said video camera signal to another format.

2. The apparatus as recited in claim 1, further comprising a control processor for controlling sending of said video camera signal from said signal converter in response to said security controller.

3. The apparatus as recited in claim 1, wherein said signal converter comprises a television tuner.

4. The apparatus as recited in claim 1, wherein said signal converter comprises a composite video signal processor.

5. The apparatus as recited in claim 1, wherein said security controller comprises motion detection processing circuitry.

6. The apparatus as recited in claim 1, wherein said security controller comprises audio detection processing circuitry.

7. The apparatus as recited in claim 2, wherein said control processor comprises a radio frequency receiver responsive to radio signals from a remote transmitter.

8. The apparatus as recited in claim 7, wherein said remote transmitter is a battery operated hand held device.

9. The apparatus as recited in claim 2, wherein said control processor is operable to couple said video camera signal from said signal converter to an input of a television in response to a user command.

10. The apparatus as recited in claim 2, wherein said control processor is operable to couple said video camera signal from said signal converter to a picture-in-picture input of a television in response to said security controller.

11. The apparatus as recited in claim 2, wherein said control processor is operable to couple said video camera signal from said signal converter to a picture-in-picture input of a television in response to a user command.

12. The apparatus as recited in claim 1, wherein said video camera signal comprises compressed digital video and audio signals.

13. An apparatus for integrating with a television for controlling display of a video camera signal received over a powerline network comprising:
a powerline modem for receiving a video camera signal over a powerline network; and
a signal converter for converting said video camera signal to a format suitable for a television input.

14. The apparatus as recited in claim 13, further comprising a security controller configured for receiving and processing detection signals indicative of a security breach condition.

15. The apparatus as recited in claim 13, wherein said video camera signal is displayed by said television in response to a user command transmitted to said television.

16. The apparatus as recited in claim 13, wherein said camera signal is displayed by said television as a picture-in-picture in response to a user command transmitted to said television.

17. The apparatus as recited in claim 13, wherein said video camera signal is automatically displayed by said television in response to a security breach detection.

18. The apparatus as recited in claim 13, wherein said video camera signal comprises compressed digital video and audio signals

19. A method for controlling a security camera signal comprising the steps of:
receiving a security camera signal over a powerline network;
detecting a security condition; and
changing said security camera signal into a form for a display device.

20. The method according to claim 19, further comprising the step of displaying said security camera signal in said form for a display device.

21. The method according to claim 20, wherein said step of displaying comprises an automatic displaying responsive to said step of detecting.

22. The method according to claim 20, wherein said step of displaying is initiated by a user.

23. The method according to claim 19, wherein said step of changing comprises use of a television tuner.

24. The method according to claim 19, wherein said step of changing comprises a composite video signal processor.

25. The method according to claim 20, wherein said step of displaying comprises displaying said security camera signal in said form for a display device a picture in a picture of a television display.

26. The method according to claim 19, wherein said step of detecting comprises motion detection of an area.

27. The method according to claim 19, wherein said security camera signal comprises compressed digital video and audio signals.

28. A computer readable medium containing software instructions that, when executed by a processor, performs the steps of:
receiving security information from a security camera over a powerline network; and
enabling display of security images received from said security camera in response to said receiving of said security information.

29. The computer readable medium according to claim 28, wherein said security information is contained in compressed digital video and audio signals.
